(19) United States
(12) Patent Application Publication
(10) Pub. No.: US 2024/0410772 A1
(43) Pub. Date: Dec. 12, 2024

(54) MEASURING SLEEVE AND METHOD FOR MEASURING A FORCE IN AN ANCHOR PILE

(71) Applicant: BAUER Spezialtiefbau GmbH, Schrobenhausen (DE)

(72) Inventors: Andreas SIMSON, Ingolstadt (DE); Manfred RAIL, Schrobenhausen OT Hörzhausen (DE)

(73) Assignee: BAUER Spezialtiefbau GmbH, Schrobenhausen (DE)

(21) Appl. No.: 18/702,115

(22) PCT Filed: Mar. 1, 2023
(86) PCT No.: PCT/EP2023/055107

§ 371 Date: Apr. 17, 2024

(30) Foreign Application Priority Data
Mar. 22, 2022 (EP) 22 163 681.4

(51) Int. Cl. G01L 5/10; G01L 1/22; G01L 25/00

(52) U.S. Cl. CPC G01L 5/10; G01L 1/22; G01L 25/00

(57) ABSTRACT

The invention relates to a measuring sleeve for measuring a force in an anchor pile which has at least two anchor rods, wherein the measuring sleeve comprises a sleeve-shaped base body with a receiving hole, wherein a first internal thread extends from one side and a second internal thread extends from a second side into the base body, the internal threads are each designed for screwing in a threaded section of an anchor rod, between the first internal thread and the second internal thread an annular central section is designed which is free from a thread, and on the central section at least one force measuring element is arranged which is axially spaced apart from the internal threads.

The invention relates to a measuring sleeve for measuring a force in an anchor pile according to claim 1 and to a method for measuring a force in an anchor pile according to claim 11.

Anchor piles that are formed of several anchor rods are in particular used in specialist foundation engineering for various purposes. For instance anchor piles are used as tension anchors for tying back excavation pit enclosures and base plates. Anchor piles can also be provided for uplift protection e.g. for structural elements under water. Likewise, use as a micropile for absorbing structural loads is basically known.

The anchor rods used to produce an anchor pile usually have a length ranging between 5 m and 15 m, the length normally being governed by transport restrictions. To form anchor piles of greater length these are usually assembled through screwing using a connecting sleeve and, after having been introduced into the ground, are anchored in the surrounding ground by introducing a cement suspension.

Common anchor rods employed to form an anchor pile are known from DE 18 13 627 B2 for example. For production-related reasons the anchor rods do not have a continuous cut-in external thread. In fact, the external thread is formed by individual threaded ribs that are separate from each other so that an interrupted thread is formed.

In anchor piles there is the need to detect their load, for instance to be able to verify an appropriate securing of the structure by the anchor piles produced.

It is known that for the detection of forces occurring on the anchor piles sensors are mounted with which the forces can be determined that are actually absorbed by an anchor pile. These sensors can be mounted on the anchor rods themselves. However, after fixing of the sensors, handling of the long anchor rods proves to be critical as the sensitive sensors can easily be damaged.

When using common anchor rods the mounting of sensors on the connecting sleeves leads to uncertain and strongly deviating measurement results. The connecting sleeves are provided with a continuous internal thread that extends over the entire axial length. When screwing in the threaded sections of the anchor rods that are designed with non-continuous threaded ribs an uneven introduction of force and load occurs over the cross section of the threaded sleeve. The measurement results of a sensor arranged on the connecting sleeve can deviate strongly depending on a screw-in position of the threaded ribs and thus a relative position with respect to the sensor. With the same load being present, different measuring values arise depending on whether the sensor is located in a region in which the partial threaded ribs of the anchor rod engage in the thread of the sleeve or in a region in which the threaded sections are exposed in the connecting sleeve.

The invention is based on the object to provide a device and a method for measuring a force in an anchor pile, with which a force in an anchor pile can be detected in a simple and reliable way.

The object is achieved on the one hand by a measuring sleeve having the features of claim 1 and on the other hand by a method having the features of claim 11. Preferred embodiments of the invention are stated in the dependent claims.

According to the invention a measuring sleeve is provided for measuring a force in an anchor pile which has at least two anchor rods, wherein the measuring sleeve comprises a sleeve-shaped base body with a receiving hole, wherein a first internal thread extends from one side and a second internal thread extends from a second side into the base body, the internal threads are each designed for screwing in a threaded section of an anchor rod, between the first internal thread and the second internal thread an annular central section is designed which is free from a thread, and on the central section at least one force measuring element is arranged which is axially spaced apart from the internal threads.

A basic idea of the invention resides in the fact that a specific measuring sleeve is provided that differs from conventional connecting sleeves with a continuous internal thread. On the measuring sleeve an annular central section is provided, on which, neither on the external side nor on the internal side, a thread is cut in or formed. This central section is designed as a receiving region to receive at least one force measuring element. The at least one force measuring element is mounted in this central section that is kept free from a thread.

The invention is based on the finding that when mounting a force measuring element on a conventional connecting sleeve with a continuous internal thread the strongly deviating measurement results can mainly be ascribed to an unsymmetrical threaded engagement between the partial threaded ribs that form an external thread on the anchor rods and the internal thread of the sleeve. This produces an uneven introduction of force over the circumference and thus an uneven load in the thread connecting region of the sleeve. By providing a central section between two lateral internal threads and arranging the at least one force measuring element in this central section it is ensured that the force measuring element is not arranged in a region of the sleeve with an uneven introduction of force.

By locating the central section spaced apart from the individual threaded regions on the sleeve it is ensured that tensions or a force flow within the sleeve can be balanced out in the central section so that, irrespective of a rotational position of a screwed in anchor rod, a reliable and consistent measuring value can be detected in the central section by the at least one force measuring element.

Basically, the internal threads can be of different design and realized according to the anchor rods provided that are to be screwed in. According to an embodiment of the invention it is preferred that the two internal threads are of the same design. The internal threads can have the same thread direction, the same thread pitch, be of the same thread type and/or have the same internal diameter.

The force measuring element can basically be mounted in any suitable location on the central section. According to an embodiment variant of the invention it is especially expedient that the at least one force measuring element is mounted on the central section on an external side of the base body. This makes it possible to provide the force measuring element with a data and/or power line in particular in a very easy way. On the external side of the central section provision can also be made for a recessed receiving space, more particularly an annular recess, in which the force measuring element can be mounted in a protected position.

By preference, the receiving hole is formed as a through hole which extends over the entire axial length of the base body. Another advantageous embodiment of the invention resides in the fact that in the receiving hole the central section protrudes radially inwards and projects radially with respect to the internal thread or recedes radially outwards and forms an annular groove. As a result, a clear spacing of the two lateral internal threads with respect to each other is achieved. In the case of a radial inward protrusion the central section can also serve as an axial stop when screwing in the threaded sections of the anchor rods. The base body of the sleeve-shaped measuring sleeve preferably has a cylindrical external contour. The central section can also be of solid design, with the receiving hole being formed by two separate blind hole regions.

To achieve consistent or repeatable measuring values it is preferred in accordance with an embodiment variant of the invention that on its external side and its internal side the central section is of smooth-surfaced design with the same wall thickness. In such a uniformly designed, in particular annular central section tensions from the anchor rods can be balanced out that are caused by an uneven introduction of force over the circumference in the axially adjoining threaded sections of the sleeve. Hence, in the central section a largely uniform elastic and/or plastic deformation of the central section can develop. These substantially uniform changes over the circumference of the central section can thus be detected reliably and with good repeat accuracy irrespective of a rotational position or relative rotational position of the force measuring element with respect to the threaded ribs of the anchor sections.

As force measuring element basically all suitable sensors can be used. According to an embodiment of the invention it is especially advantageous and efficient if at least one strain gauge is provided as force measuring element. A strain gauge can be firmly mounted on, in particular affixed to the central section. Expansions of the central section resulting from a force applied to the central section or rather the measuring sleeve can be detected by the strain gauge and transformed into an electric signal. If necessary, the electric signal can be forwarded in an amplified manner to an evaluation means. This can take place in a line-based or wireless way.

The invention further comprises an anchor pile with at least two anchor rods which have a threaded section on at least one end, wherein the threaded sections are screwed into a measuring sleeve according to the invention and the anchor rods are connected to each other by the measuring sleeve. By preference, the anchor rods can be designed with threaded sections at their two free ends or with a thread along their entire length. Moreover, the anchor pile can also be constructed of more than two anchor rods, with a connecting sleeve being in each case arranged between two adjoining anchor rods. In this case, one or several sleeves can be designed as measuring sleeves according to the invention.

The anchor pile with the at least two mutually connected anchor rods can be introduced into a borehole for producing a bored or anchoring pile. Starting from the at least one force measuring element a measuring line can extend along an external side of the anchor pile thus formed. The measuring line can be designed to convey data and preferably also electric power.

According to a further embodiment of the invention provision is made in that at least one threaded section of an anchor rod is designed with threaded ribs which form an interrupted thread. The anchor rod with the thread can thus be produced in a particularly efficient way, for instance through hot rolling and/or cold rolling. Such anchor rods are common on the market and can be acquired at low cost. Despite the design of the threaded sections with individual threaded ribs and thus without the design of a continuous external thread reliable measuring values of the actual force absorption of an anchor pile can be achieved in conjunction with the measuring sleeve according to the invention. This proves to be advantageous for a reliable testing and assurance of a correct anchoring e.g. of a structure in the ground or a bottom of a body of water.

The anchor pile formed of the at least two anchor rods and the connecting sleeve can be used for a variety of applications. According to a further development of the invention it is particularly expedient that the anchor pile is designed as a micropile, a tension anchor or an uplift anchor. The introduction of the anchor pile into a vertical bore can be used to form a micropile in the ground. The micropile can absorb vertically directed forces e.g. of a structure both in the upward and in the downward direction and transfer these into the ground. Moreover, by way of the anchor pile according to the invention it is also possible to create a tension element or tension anchor, for instance for tying back a retaining wall in the ground or for an excavation pit enclosure. In particular, the anchor pile according to the invention can also be employed under water and by particular preference in offshore applications. The anchor pile can also be formed of more than two anchor rods, in which case at least one measuring sleeve and, where necessary, further conventional connecting sleeves are arranged.

The anchor pile can thus be introduced into the bottom of a body of water and used as uplift protection for underwater structures or foundations for example. To form the respective element the anchor pile is preferably inserted into a bore, with a surrounding free space being filled with a hardenable suspension, in particular a cement suspension.

The method according to the invention for measuring a force in an anchor pile is characterized in that an anchor pile according to the invention is formed and in that for measurement measuring data on tensile and/or compressive forces are generated by the at least one force measuring element. For this purpose the measuring sleeve according to the invention is used on the anchor pile. In addition to the tensile and/or compressive forces shear or torsional forces as well as other forces that may be of interest can also be detected by way of the measuring sleeve.

In accordance with the invention a preferred method variant resides in the fact that the measurement takes place continuously or at discrete points in time. In particular, measurement can not only take place during the production of the anchor pile but in particular after introduction into a ground region with a large time lag to that of the production. In this way, for example a long-term monitoring of a structure can also be achieved. The at least one force measuring element is connected to an evaluation unit that can transform the detected measuring signals into corresponding data on force application. The evaluation unit can also emit a warning signal, with which indication can be made e.g. to the monitoring personnel that predetermined limit values have been exceeded.

To achieve especially precise measurement results provision is made in accordance with a further development of the invention that when the anchor rods are screwed in, a defined test force is applied at least once to the measuring sleeve to calibrate the at least one force measuring element. For calibration the same or different test forces can also be applied repeatedly to an anchor pile formed. Based on this one or the several defined test forces the resulting signals of the at least one force measuring element can then be calibrated. This increases the subsequent measuring accuracy.

The invention is described further hereinafter by way of preferred embodiments illustrated schematically in the drawings, wherein show:

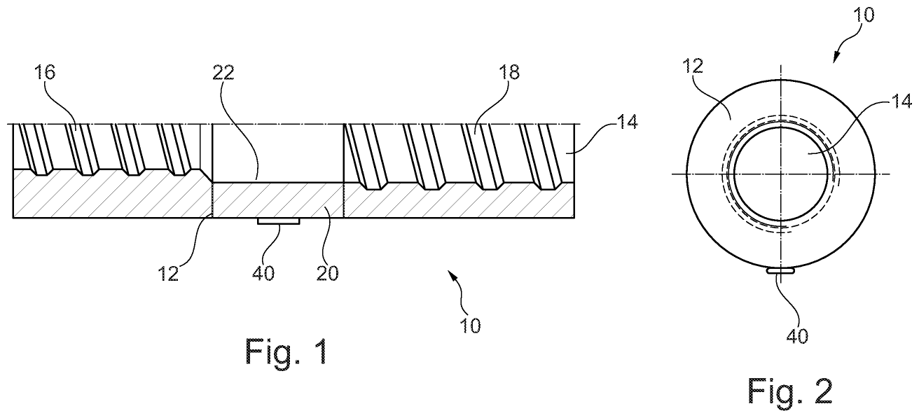

FIG. 1 a schematic semi-cross sectional illustration of a measuring sleeve according to the invention;

FIG. 2 a front view of the measuring sleeve of FIG. 1;

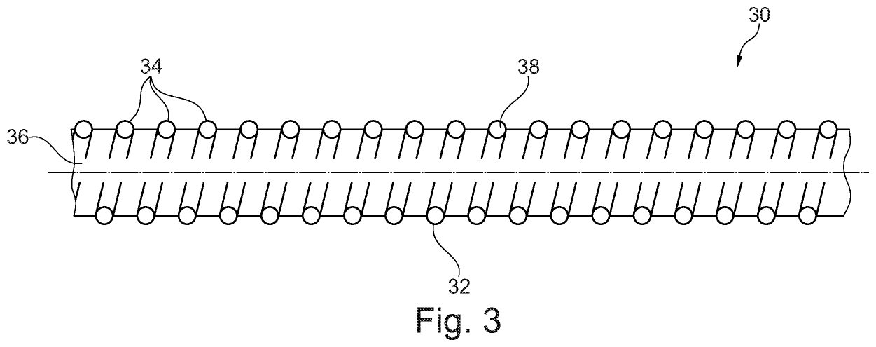

FIG. 3 a side view of a threaded section of an anchor rod; and

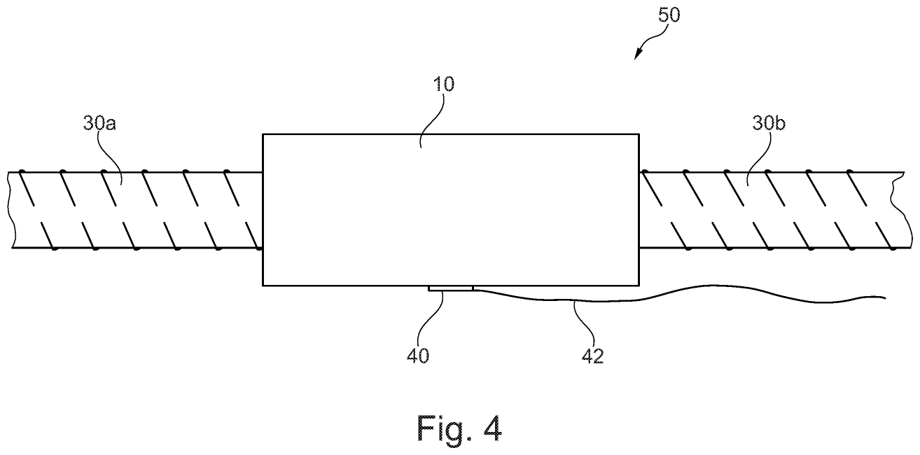

FIG. 4 a partial side view of an anchor pile according to the invention.

According to the embodiment pursuant to FIGS. 1 and 2 a measuring sleeve 10 according to the invention has a sleeve-shaped base body 12 with a receiving hole 14 that can be continuous. On one side of the base body 12 a first internal thread 16 is introduced into a first section whereas on the opposite side of the base body 12 a second internal thread 18 is designed in a second section. Depending on the anchor rods to be screwed in the first internal thread 16 and the second internal thread 18 can be of the same or of different design.

Between the first internal thread 16 and the second internal thread 18 an annular central section 20 is designed in a center region of the base body 12, which can be produced by screwing in an annular groove 22 for example. Through the central section 20 the two internal threads 16, 18 are axially spaced apart from each other. A wall thickness in the annular central section 20 can be designed the same over the circumference.

On a preferably cylindrical external side of the measuring sleeve 10 at least one force measuring element 40 is mounted in the circumferential region of the central section 20, by preference in an axial center. The force measuring element 40 can in particular be a so-called strain gauge that is affixed to the external side of the base body 12. By way of the force measuring element 40 changes of shape occurring on the central section 20 can be detected as a measure for acting forces and forwarded to an evaluation means.

According to FIG. 3 a threaded section 32 of an anchor rod 30 is illustrated. The external thread on the anchor rod 30 is formed by mutually separate threaded ribs 34 that are separated from each other by axially extending plane regions 36. In this way, an interrupted thread 38 is formed by the threaded ribs 34 on the anchor rod 30. Compared to a continuous thread such an interrupted thread 38 can be produced efficiently, whereby anchor rods 30 with a high tensile strength can be achieved on the whole. The threaded section 32 can extend over the entire length of an anchor rod 30 or only be designed in the end regions of an anchor rod 30.

By way of at least two anchor rods 30 and a measuring sleeve 10 according to the invention an anchor pile 50 according to the invention, illustrated partially in FIG. 4, can be formed in that a first anchor rod 30a is screwed into the first internal thread 16 and a second anchor rod 30b is screwed into the second internal thread 18. The threaded connections do not extend into the central region 20 of the measuring sleeve 10 as this is kept free from an internal thread on its internal side.

Due to the fact that the interrupted threaded ribs 34 cause an uneven force introduction of tensile and/or compressive forces from the anchor rods 30 into the measuring sleeve 10 in the threaded sections, a reliable force measurement can hardly take place in these regions as the force measurement strongly depends on the rotational position of the screwed in anchor rod 30 relative to the measuring sleeve 10. By contrast, in the central section 20 that is kept free a uniform distribution of force and tension is brought about over the circumferential cross section so that a particularly reliable measuring value of an axial force acting in the anchor pile 50 can be detected by an applied force measuring element 40.

By means of a measuring line 42 that extends from the force measuring element 40 along a longitudinal axis of the anchor pile 50 up to a measurement and evaluation means, not illustrated, a reliable data transmission and evaluation of the detected measuring values can be achieved.

1.-13. (canceled)

14. A measuring sleeve for measuring a force in an anchor pile which has at least two anchor rods, wherein
the measuring sleeve comprises a sleeve-shaped base body with a receiving hole,
wherein
a first internal thread extends from one side and a second internal thread extends from a second side into the base body,
the internal threads are each designed for screwing in a threaded section of an anchor rod,
between the first internal thread and the second internal thread an annular central section is designed which is free from a thread and through which the two internal threads are axially spaced apart from each other, and
on the central section at least one force measuring element is arranged
which is axially spaced apart from the internal threads,
wherein
on its external side and its internal side the central section is of smooth-surfaced design and
the central section is designed with the same wall thickness.

15. The measuring sleeve according to claim 14,
wherein
the two internal threads are of the same design.

16. The measuring sleeve according to claim 14,
wherein
the at least one force measuring element is mounted on the central section on an external side of the base body.

17. The measuring sleeve according to claim 14,
wherein
in the receiving hole the central section protrudes radially inwards and projects radially with respect to the internal thread or recedes radially outwards and forms an annular groove.

18. The measuring sleeve according to claim 14,
wherein
as force measuring element at least one strain gauge is provided.

19. An anchor pile with at least two anchor rods which have a threaded section on at least one end,
wherein
the threaded sections are screwed into a measuring sleeve according to claim 14 and the anchor rods are connected to each other by the measuring sleeve.

20. The anchor pile according to claim 19,
wherein
a measuring line is provided which extends from the force measuring element along the anchor pile.

21. The anchor pile according to claim 19,
wherein
at least one threaded section of an anchor rod is designed with threaded ribs which form an interrupted thread.

22. The anchor pile according to claim 19,
wherein
the anchor pile is designed as a micropile, a tension anchor or an uplift anchor.

23. A method for measuring a force in an anchor pile,
wherein
an anchor pile according to claim 19 is formed and for measurement measuring data on tensile and/or compressive forces are generated by the at least one force measuring element.

24. The method according to claim 23,
wherein
the measurement takes place continuously or at discrete points in time.

25. The method according to claim 23,
wherein
when the anchor rods are screwed in, a defined test force is applied at least once to the measuring sleeve to calibrate the at least one force measuring element.
